(19) United States
(12) Patent Application Publication
(10) Pub. No.: US 2023/0116764 A1
(43) Pub. Date: Apr. 13, 2023

(54) APPARATUS AND METHOD FOR PERSONAL IDENTIFICATION BASED ON DEEP NEURAL NETWORK

(71) Applicant: RESEARCH & BUSINESS FOUNDATION SUNGKYUNKWAN UNIVERSITY, Suwon-si (KR)

(72) Inventors: Yu Sung KIM, Suwon-si (KR); Seung Hwan SHIN, Suwon-si (KR); Keun Hong CHAE, Suwon-si (KR); Seong Hyun BAN, Suwon-si (KR); Seung Hyeon KIM, Suwon-si (KR)

(73) Assignee: RESEARCH & BUSINESS FOUNDATION SUNGKYUNKWAN UNIVERSITY, Suwon-si (KR)

(21) Appl. No.: 17/964,441

(22) Filed: Oct. 12, 2022

(30) Foreign Application Priority Data
Oct. 13, 2021 (KR) 10-2021-0135882

(51) Int. Cl. G06N 3/094

(52) U.S. Cl. CPC G06N 3/094; H04B 1/7163

(57) ABSTRACT

The present disclosure relates to an apparatus and a method for personal identification based on a deep neural network. According to an exemplary embodiment of the present disclosure, a personal identification method includes receiving a plurality of wireless signals including spatial information and identification information of an object to be identified, by means of a plurality of receivers in different positions, by a wireless signal collecting unit, generating a manipulation signal from the wireless signal by processing the spatial information by means of a first deep neural network model which is trained in advance, by a manipulation signal generating unit, and identifying the object to be identified in a specific space with identification information of the object to be identified of the manipulation signal as an input of the second deep neural network model, by a personal identification processing unit.

### CROSS-REFERENCE TO RELATED APPLICATIONS

This application claims the priority of Korean Patent Application No. 10-2021-0135882 filed on Oct. 13, 2021, in the Korean Intellectual Property Office, the disclosure of which is incorporated herein by reference.

### BACKGROUND

### Field

The present disclosure relates to an apparatus and a method for personal identification based on a deep neural network.

### Description of the Related Art

A technology related to personal identification, position estimation, and posture estimation for a specific object, specifically, person in a specific space may be utilized in various fields, such as games, medical cares, disasters, firefighting, military, and security.

In the field of computer vision, personal identification develops to a way that applies machine learning from a decision based technology of the related art and has made great steps in estimation speed and accuracy.

In the field of computer vision of the related art, as a personal identification technique, a method of estimating an identity of a person from an image was used. However, according to the image-based method, when the space is dark so that an image is not properly formed or an entire shape of the people is not properly seen due to the obstacle in the space, there is a problem in that an object to be identified is not properly identified.

Accordingly, when a wireless communication signal is used, the wireless communication signal is not only used regardless of the brightness of the surrounding space, but also has a characteristic which is transmissible through the wall so that it is easy to identify an object to be identified in a non-visible region.

However, the wireless communication signal of the related art sequentially uses a frequency band of a broadband so that an amount of information to be acquired as compared with a reception time of the wireless signal is not so much. Further, even in the same space, a path and an aspect of the signal are very different depending on a position where the wireless signal is received so that it is difficult to handle the signal.

### SUMMARY

An object of the present disclosure is to provide an apparatus and a method for personal identification which may identify an object to be identified in a specific space regardless of an obstacle, and transmit and receive a large amount of information in a broadband within a short time using an ultra-wideband wireless signal.

Further, another object of the present disclosure is to provide an apparatus and a method for personal identification which may accurately identify an object to be identified even though a wireless signal collection position varies in the same space.

Further, still another object of the present disclosure is to provide an apparatus and a method for personal identification which may remarkably improve an identification accuracy of an object to be identified in an un-trained position by mutually training different deep neural network models.

The object of the present disclosure is not limited to the above-mentioned objects and other objects and advantages of the present disclosure which have not been mentioned above can be understood by the following description and become more apparent from exemplary embodiments of the present disclosure. Further, it is understood that the objects and advantages of the present disclosure may be embodied by the means and a combination thereof in the claims.

According to an aspect of the present disclosure, a personal identification method includes receiving a plurality of wireless signals including spatial information and identification information of an object to be identified, by means of a plurality of receivers in different positions, by a wireless signal collecting unit; generating a manipulation signal from the wireless signal by processing the spatial information by means of a first deep neural network model which is trained in advance, by a manipulation signal generating unit; and identifying the object to be identified in a specific space with identification information of the object to be identified of the manipulation signal as an input of the second deep neural network model, by a personal identification processing unit.

Further, in an exemplary embodiment of the present disclosure, the generating of a manipulation signal includes comparing different spatial information to maintain a common parameter having the same value and remove an individual parameter having different values to generate the manipulation signal.

Further, according to one aspect of the present disclosure, the personal identification method includes determining whether the individual parameter is removed from the manipulation signal by means of a third deep neural network model, by the position estimation unit.

Further, in an exemplary embodiment of the present disclosure, the first deep neural network model and the third deep neural network model are mutually trained by means of a generative adversarial network (GAN).

Further, in an exemplary embodiment of the present disclosure, the personal identification processing unit feeds back the personal identification accuracy which is an identification result of the object to be identified to the manipulation signal generating unit according to a predetermined period, and the first deep neural network model is trained so as not to process the identification information of the object to be identified when the personal identification accuracy is continuously reduced during a predetermined reference period.

Further, in an exemplary embodiment of the present disclosure, the wireless signal is an ultra-wideband signal (UWB) which is an ultra-wideband wireless signal.

According to an aspect of the present disclosure, the personal identification apparatus includes a wireless signal collecting unit which receives a plurality of wireless signals including spatial information and identification information of an object to be identified by means of a plurality of receivers in different positions; a manipulation signal generating unit which generates a manipulation signal from the wireless signal by processing the spatial information by means of a first deep neural network model which is trained in advance; and a personal identification processing unit which identifies the object to be identified in a specific space with identification information of the object to be identified of the manipulation signal as an input of the second deep neural network model.

Further, in an exemplary embodiment of the present disclosure, the manipulation signal generating unit compares different spatial information to maintain a common parameter having the same value and remove an individual parameter having different values to generate the manipulation signal.

Further, according to one aspect of the present disclosure, the personal identification apparatus further includes a position estimation unit which determines whether the individual parameter is removed from the manipulation signal by means of a third deep neural network model.

Further, in an exemplary embodiment of the present disclosure, the first deep neural network model and the third deep neural network model are mutually trained by means of a generative adversarial network (GAN).

Further, in an exemplary embodiment of the present disclosure, the personal identification processing unit feeds back the personal identification accuracy which is an identification result of the object to be identified to the manipulation signal generating unit according to a predetermined period, and the first deep neural network model is trained so as not to process the identification information of the object to be identified when the personal identification accuracy is continuously reduced during a predetermined reference period.

Further, in an exemplary embodiment of the present disclosure, the wireless signal is an ultra-wideband (UWB) signal which is an ultra-wideband wireless signal.

According to an exemplary embodiment of the present disclosure, an apparatus and a method for personal identification may identify an object to be identified in a specific space regardless of an obstacle, and transmit and receive a large amount of information in a broadband within a short time using an ultra-wideband wireless signal.

Further, the personal identification apparatus and method according to the exemplary embodiment of the present disclosure may accurately identify the object to be identified in the same space even in a different collection position of the wireless signal.

Further, the personal identification apparatus and method according to the exemplary embodiment of the present disclosure mutually train the different deep neural network models to significantly improve the identification accuracy of the object to be identified in a non-trained position.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a personal identification apparatus according to an exemplary embodiment of the present disclosure;

FIG. 2 is a detailed diagram of a personal identification apparatus according to an exemplary embodiment of the present disclosure;

FIG. 3 is a table illustrating a performance of a personal identification apparatus according to an exemplary embodiment of the present disclosure; and

FIG. 4 is a flowchart of a personal identification method according to an exemplary embodiment of the present disclosure.

### DETAILED DESCRIPTION OF THE EMBODIMENT

Those skilled in the art may make various modifications to the present disclosure and the present disclosure may have various embodiments thereof, and thus specific embodiments will be illustrated in the drawings and described in detail in detailed description. However, this does not limit the present disclosure within specific exemplary embodiments, and it should be understood that the present disclosure covers all the modifications, equivalents and replacements within the spirit and technical scope of the present disclosure. In the description of respective drawings, similar reference numerals designate similar elements.

Terms such as first, second, A, or B may be used to describe various components, but the components are not limited by the above terms. The above terms are used only to distinguish one component from the other component. For example, without departing from the scope of the present disclosure, a first component may be referred to as a second component, and similarly, a second component may be referred to as a first component. A term of and/or includes combination of a plurality of related elements or any one of the plurality of related elements.

It should be understood that, when it is described that an element is “coupled” or “connected” to another element, the element may be directly coupled or directly connected to the other element or coupled or connected to the other element through a third element. In contrast, when it is described that an element is “directly coupled” or “directly connected” to another element, it should be understood that no element is not present therebetween.

Terms used in the present application are used only to describe a specific exemplary embodiment, but are not intended to limit the present disclosure. A singular form may include a plural form if there is no clearly opposite meaning in the context. In the present disclosure, it should be understood that terminology “include” or “have” indicates that a feature, a number, a step, an operation, a component, a part or the combination thoseof described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

Hereinafter, an exemplary embodiment of the present disclosure will be described in detail with reference to the accompanying drawings.

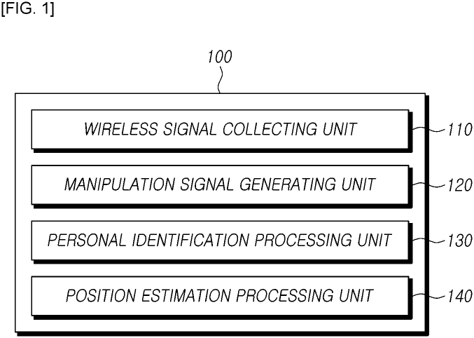

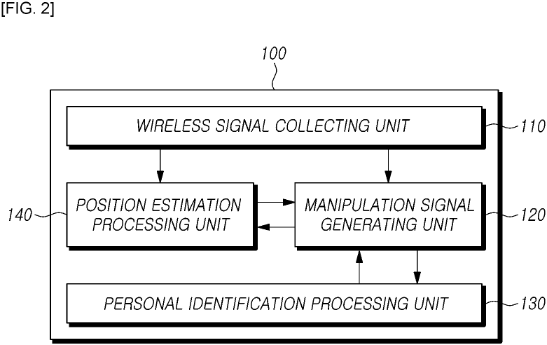

FIG. 1 is a block diagram of a personal identification apparatus according to an exemplary embodiment of the present disclosure and FIG. 2 is a detailed diagram of a personal identification apparatus according to an exemplary embodiment of the present disclosure.

Referring to FIGS. 1 and 2, the personal identification apparatus 100 is an apparatus which identifies an object to be identified present in a specific space using a plurality of deep neural network models, and includes a wireless signal collecting unit 110, a manipulation signal generating unit 120, a personal identification processing unit 130, and a position estimation processing unit 140.

The object to be identified refers to a person who is an object to be identified by the personal identification apparatus.

The wireless signal collecting unit 110 collects a wireless signal which is generated and transmitted by a wireless signal transmitter, by means of a receiver. A plurality of wireless signal transmitter and receiver pairs may be provided and disposed in different positions in a specific space. For example, the wireless signal transmitter and receiver may be disposed in nine different positions in a specific space.

The wireless signal may be used regardless of a brightness of the surrounding space and has a property of being able to pass through the wall, and may include spatial information and identification information.

Here, the spatial information includes three-dimensional position information of a receiver which receives a wireless signal in a specific space and three-dimensional position information of the object to be identified, and the identification information includes overall external appearance information (for example, a form, a shape, or a posture of the object to be identified) to identify the object to be identified.

The wireless signal collecting unit 110 may directly receive a wireless signal transmitted from the wireless signal transmitter or receive a wireless signal which is reflected by a wall or the object to be identified.

The spatial information and the identification information included in the received wireless signal may vary depending on various elements such as a distance of the object to be identified from the transmitter/receiver, a reflection degree, a posture of the object to be identified, and a height or a body shape of a human body.

In the meantime, the wireless signal may be an ultra-wideband wireless signal. For example, the wireless signal may be an ultra-wideband (UWB) signal, but is not necessarily limited thereto, and may include all wireless signals using a frequency band of ultra-wideband.

When the ultra-wideband wireless signal is used, it is advantageous in that a signal in a wide band is transmitted and received in a short time. Further, objects and people in the space have different diffractive, reflective, and transmissive characteristics in each frequency, depending on a medium so that when a broadband signal is used, more information may be utilized for personal identification.

Further, when the wireless signal is used, a limitation of an image blocking phenomenon due to obstacles may be overcome and specifically, when an UWB signal which is an ultra-wideband is used, several bands are simultaneously used to acquire a large amount of information for the same reception time.

The manipulation signal generating unit 120 generates a manipulation signal from a wireless signal by processing spatial information by means of a first deep neural network model which is trained in advance.

Specifically, the manipulation signal generating unit 120 inputs spatial information included in a plurality of wireless signals to the first deep neural network model to compare the spatial information. Thereafter, the manipulation signal generating unit 120 maintains a common parameter having the same value among a plurality of parameters included in the spatial information and removes individual parameters having different values to generate a manipulation signal. That is, the generated manipulation signal includes spatial information obtained by removing individual parameters from the wireless signal and identification information of an object to be identified.

As described above, the manipulation signal generating unit 120 generates a manipulation signal by removing the individual parameters so that the personal identification processing unit to be described below may recognize that all the plurality of received wireless signal is received from the same receiver.

Accordingly, regardless of a signal acquisition position of the receiver, to be more specific, regardless of a path of the signal, the object to be identified may be stably identified by the personal identification processing unit. Further, a receiver may be provided in an arbitrary position desired by the user, by means of this process, without limiting an installation position of the receiver.

In the meantime, a first deep neural network model which generates the manipulation signal may be configured by nine 1D convolution layers and three fully connected layers, and trained in advance by repeatedly collecting the wireless signal.

The personal identification processing unit 130 identifies the object to be identified in a specific space with identification information of the object to be identified of the manipulation signal as an input of the second deep neural network model.

As described above, the identification information includes overall external appearance information (for example, a form, a shape, or a posture) to identify the object to be identified, and the personal identification processing unit 130 identifies an object to be identified using external appearance information of the object to be identified included in the identification information.

For example, the personal identification processing unit 130 may identify a shape of the object to be identified and a posture or a body shape held by the object to be identified.

In the meantime, the second deep neural network model may be configured by seven 1D convolutional layers and two fully connected layers, and the learning may be performed so as to minimize a binary cross entropy loss generated during the learning.

The position estimation processing unit 140 evaluates a manipulation degree of the manipulation signal generated from the manipulation signal generating unit 130. That is, the position estimation processing unit 140 determines whether the individual parameter is removed from the manipulation signal by means of a previously trained third deep neural network model to evaluate the manipulation degree of the manipulation signal.

If all the individual parameters are removed from the spatial information, the manipulation degree of the manipulation signal is high so that the position estimation processing unit 140 may determine that the wireless signals are acquired from the same receiver.

In contrast, if all the individual parameters are not removed from the spatial information, the manipulation degree of the manipulation signal is low so that the position estimation processing unit 140 may determine that the wireless signals are acquired from different receivers.

As described above, the first deep neural network model and the third deep neural network model are trained by means of a generative adversarial network (GAN).

That is, the manipulation signal generating unit 120 is a generator to generate a manipulation signal to determine that the position estimation processing unit 140 acquires the wireless signal in the same position, and the position estimation processing unit 140 is a discriminator to determine whether the generated manipulation signal is acquired from the same position or different positions.

As described above, the first deep neural network model and the third deep neural network model may be trained to each other by a minmax game of the generative adversarial network.

In the meantime, in the exemplary embodiment of the present disclosure, the personal identification processing unit 130 feeds back an identification result of the object to be identified to the manipulation signal generating unit according to a predetermined period to retrain the first deep neural network model.

Specifically, the personal identification processing unit 130 transmits a personal identification accuracy (%) which is an identification result of the object to be identified according to a predetermined period to the manipulation signal generating unit. Here, the predetermined period is a period which is set in advance and may be an average time when the manipulation signal is input to the personal identification processing unit 130 and an identification result for the manipulation signal is output.

Thereafter, the first deep neural network model is trained so as not to process the identification information of the object to be identified when the personal identification accuracy is continuously reduced during a predetermined reference period.

The predetermined reference period, for example, may be a reference period that is objectively determined that the personal identification accuracy is obviously reduced as the learning is progressed, such as three periods or five periods.

When the personal identification accuracy is continuously reduced during a reference period, it may be determined that the manipulation signal generating unit 130 processes not only the personal parameters of the spatial information, but also the identification information of the object to be identified when the manipulation signal is generated. Accordingly, the first deep neural network model may be retrained so as not to process the identification information by the retraining by the feedback.

As described above, the loss generated by the relationship of the manipulation signal generating unit 130 and the personal identification processing unit 140 is the cross entropy loss, and the first deep neural network model of the manipulation signal generating unit may be trained to minimize the cross entropy loss.

In the meantime, the first deep neural network model of the manipulation signal generating unit 120, the second deep neural network model of the personal identification processing unit 130, and the third deep neural network model of the position estimation processing unit 140 may be models which are trained or were trained by different networks.

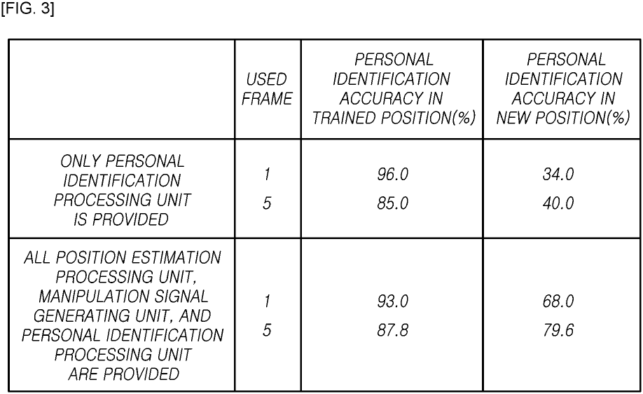

As described above, the first deep neural network model, the second deep neural network model, and the third deep neural network model are compensated and trained by mutual learning, respectively. The performance of the personal identification apparatus by the mutual learning of each deep neural network model may be confirmed from FIG. 3.

FIG. 3 is a table illustrating a performance of a personal identification apparatus according to an exemplary embodiment of the present disclosure.

Referring to the drawing, the performance of the personal identification apparatus is separately evaluated when only the personal identification processing unit is used, and when all the personal identification processing unit, the manipulation signal generating unit, and the position estimation processing unit are used. Further, the performance in the position of the receiver which is used for the learning and the performance in the position of the receiver which is not used for the learning are separately evaluated to evaluate the performance of the personal identification apparatus.

When only the first deep neural network model of the personal identification processing unit 130 is used, a relatively high personal identification accuracy in the trained position is relatively high, which is 96% and 85% in the frames 1 and 5, respectively. However, the personal identification accuracy in a new position which is not trained, is 34% and 40%, respectively, to be significantly low.

In contrast, when not only the first deep neural network model of the personal identification processing unit 130, but also the second deep neural network model of the manipulation signal generating unit 120 and the third deep neural network model of the position estimation processing unit 140 are used together, the personal identification accuracy in the trained position is 93% and 87.8% in frames 1 and 5, which is not significantly different from the case in which the only the first deep neural network model is used. However, it may be confirmed that the personal identification accuracy in the new position which is not trained is 68% and 79.6%, respectively, which is significantly improved.

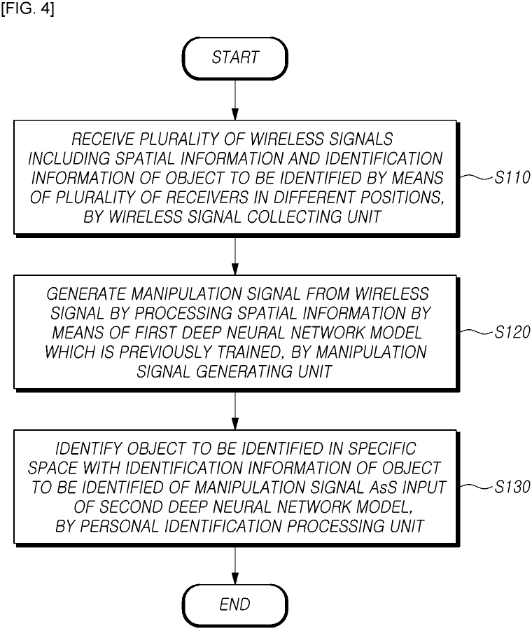

FIG. 4 is a flowchart of a personal identification method according to an exemplary embodiment of the present disclosure.

Referring to FIG. 4, the wireless signal collecting unit receives a plurality of wireless signals including spatial information and identification information of the object to be identified, by means of a plurality of receivers in different positions, in step S110.

Thereafter, the manipulation signal generating unit generates a manipulation signal from a wireless signal by processing spatial information by means of a first deep neural network model which is trained in advance, in step S120.

Finally, the personal identification processing unit identifies the object to be identified in a specific space with identification information of the object to be identified of the manipulation signal as an input of the second deep neural network model, in step S130.

As described above, according to an exemplary embodiment of the present disclosure, a personal identification apparatus and a method may identify an object to be identified in a specific space regardless of an obstacle, and transmit and receive a large amount of information in a broadband within a short time using an ultra-wideband wireless signal.

Further, the personal identification apparatus and method according to the exemplary embodiment of the present disclosure may accurately identify the object to be identified in the same space even in a different collection position of the wireless signal.

Further, the personal identification apparatus and method according to the exemplary embodiment of the present disclosure may significantly improve the identification accuracy of the object to be identified in the position which is not trained.

As described above, although the present disclosure has been described with reference to the exemplary drawings, it is obvious that the present disclosure is not limited by the exemplary embodiment and the drawings disclosed in the present disclosure and various modifications may be performed by those skilled in the art within the range of the technical sprit of the present disclosure. Further, although the effects of the configuration of the present disclosure have not been explicitly described while describing the exemplary embodiments of the present disclosure, it is natural that the effects predictable by the configuration should also be recognized.

What is claimed is:

1. A personal identification method using a plurality of deep neural network models, comprising:
receiving a plurality of wireless signals including spatial information and identification information of an object to be identified, by means of a plurality of receivers in different positions, by a wireless signal collecting unit;
generating a manipulation signal from the wireless signal by processing the spatial information by means of a first deep neural network model which is trained in advance, by a manipulation signal generating unit; and
identifying the object to be identified in a specific space with identification information of the object to be identified of the manipulation signal as an input of the second deep neural network model, by a personal identification processing unit.

2. The personal identification method according to claim 1, wherein the generating of a manipulation signal includes:
comparing different spatial information to maintain a common parameter having the same value and remove an individual parameter having different values to generate the manipulation signal.

3. The personal identification method according to claim 2, comprising:
determining whether the individual parameter is removed from the manipulation signal by means of a third deep neural network model, by the position estimation unit.

4. The personal identification method according to claim 3, wherein the first deep neural network model and the third deep neural network model are mutually trained by means of a generative adversarial network (GAN).

5. The personal identification method according to claim 3, wherein the personal identification processing unit feeds back the personal identification accuracy which is an identification result of the object to be identified to the manipulation signal generating unit according to a predetermined period, and
the first deep neural network model is trained so as not to process the identification information of the object to be identified when the personal identification accuracy is continuously reduced during a predetermined reference period.

6. The personal identification method according to claim 1, wherein the wireless signal is an ultra-wideband (UWB) signal which is an ultra-wideband wireless signal.

7. A personal identification apparatus using a plurality of deep neural network models, comprising:
a wireless signal collecting unit which receives a plurality of wireless signals including spatial information and identification information of an object to be identified, by means of a plurality of receivers in different positions;
a manipulation signal generating unit which generates a manipulation signal from the wireless signal by processing the spatial information by means of a first deep neural network model which is trained in advance; and
a personal identification processing unit which identifies the object to be identified in a specific space with identification information of the object to be identified of the manipulation signal as an input of the second deep neural network model.

8. The personal identification apparatus according to claim 7, wherein the manipulation signal generating unit compares spatial information to maintain a common parameter having the same value and remove an individual parameter having different values to generate the manipulation signal.

9. The personal identification apparatus according to claim 8, further comprising:
a position estimation unit which determines whether the individual parameter is removed from the manipulation signal by means of a third deep neural network model.

10. The personal identification apparatus according to claim 9, wherein the first deep neural network model and the third deep neural network model are mutually trained by means of a generative adversarial network (GAN).

11. The personal identification apparatus according to claim 9, wherein the personal identification processing unit feeds back the personal identification accuracy which is an identification result of the object to be identified to the manipulation signal generating unit according to a predetermined period, and
the first deep neural network model is trained so as not to process the identification information of the object to be identified when the personal identification accuracy is continuously reduced during a predetermined reference period.

12. The personal identification apparatus according to claim 7, wherein the wireless signal is an ultra-wideband (UWB) signal which is an ultra-wideband wireless signal.
